(19) United States
(12) Patent Application Publication
(10) Pub. No.: US 2026/0186952 A1
(43) Pub. Date: Jul. 2, 2026

(54) DATABASE APPLICATION TRACING

(71) Applicant: Datadog, Inc., New York, NY (US)

(72) Inventors: Justin James Iso, New York, NY (US); Nenad Noveljic, Zurich (CH); Alexandre Nicolas Bressani-Normand, Nelson (CA)

(21) Appl. No.: 19/006,987

(22) Filed: Dec. 31, 2024

(51) Int. Cl. G06F 11/362; G06F 11/3604; G06F 16/21

(52) U.S. Cl. CPC G06F 11/364; G06F 11/3612; G06F 16/217

(57) ABSTRACT

Methods, systems, and apparatus, including computer programs encoded on a computer storage medium, for generating trace log messages. A database server may include an agent or other feature to monitor and track performance of the database server to generate the trace log messages. The agent can use one or more identifiers associated with the database commands to generate the trace log messages. In particular, the agent can obtain such identifiers as part of the context data that is associated with a session established between a client application and the database server.

### TECHNICAL FIELD

The specification relates to trace logging. Specifically, the specification relates to generating distributed trace logs that span web applications and database management systems.

### BACKGROUND

In a database system, trace logging is a form of computer logging useful for recording information about the execution of database operations. A database management system can record operational information, warnings, error conditions, or other information about the execution of database operations in trace logs, which may subsequently be used by software developers, system administrators, and other personnel to troubleshoot errors or problems that arise at runtime, analyze database system or application behavior, and so on. For example, a trace log message written to the trace log may include a time of occurrence of a database operation, a description of the database operation, and a user of an application program associated with the database operation.

### SUMMARY

The specification describes technology for generating trace logs for a database server. The database server includes a set of hardware, software, and/or infrastructure components (such as power supplies, power distribution units, cooling/heating equipment, networking equipment and the like) for storing data. For example, the database server can include one or more database systems (e.g., relational or non-relational databases), file systems, other data storage systems, or a combination thereof.

The database server can also include one or more database management systems. A database management system can organize data stored in the database server, allowing quick and convenient access by a client application to retrieve stored data. Examples of database management systems include relational database management systems, hierarchical database management systems, and network database management systems.

The client application can submit data access statements to the database server. Examples of data access statements that can be submitted from the client application to the database server include read, write, update, and delete statements. Once received, the database management system can obtain an execution plan for a data access statement. For example, the execution plan can be retrieved from a cache if an execution plan associated with the data access statement already exists. As another example, the execution plan can be generated by using a statement parser and, optionally, a statement optimizer.

The database server may include an agent or other feature to monitor and track performance of the database server to generate trace log messages. When a client application submits a database command in the form of a data access statement to perform a database operation on the database server, the database server can use an agent (e.g., a database agent) to generate a trace log which describes details for the operations performed by the database server to execute the data access statement.

The database agent can use snapshot data to generate the trace log messages. Snapshot data represents timed information about the internal functionality of the database server. For example, times to store data, times to find and read data and/or times to delete data can be captured in snapshot data.

To generate trace log messages that are associated with individual database commands based on snapshot data, the database agent makes use of one or more identifiers associated with the database command that can uniquely identify each database command from among a plurality of database commands that may be executed at a same time point on the database server. For example, for a database command, the one or more identifiers can include a trace identifier and a span identifier associated with the database command.

Notably, the database agent can obtain such identifiers as part of the context data that is associated with a session established between the client application and the database server. By providing identifiers that will be utilized by the database agent to generate trace log messages as part of context data associated with database sessions, various implementations of the techniques can realize one or more of the following advantages.

For one, the high computing cost of modifying the data access statements (to add identifiers as comments) in a database management system can be avoided. For example, the database management system may rely on a cache of data access statements for repeatable execution, but in the case where the data access statements are repeatedly modified, the plans generated from previous database commands cannot be reused because the data access statements are different even for the same database command.

In contrast, the described techniques enable the database management system to more practically reuse plans generated for historic database commands for more computing resource-efficient and faster execution of the database commands. The database management system can thus achieve higher throughput transactions per second (TPS). A higher TPS means that the time required to process a database command can be reduced—or, put another way—a greater number of database commands can be processed within a fixed length of time.

For another, the database management system can process database commands with lower latency. That is, the database management system can provide a result of the execution of a database command to a client system more quickly than some existing database management systems, e.g., a database management system that relies on identifiers embedded as comments in the data access statements.

For another, a database management system can operate using fewer storage resources, e.g., using fewer processor cycles (e.g., CPU cycles), using less memory or disk space, or both, than might otherwise be required by conventional trace logging techniques. This enables a database management system to devote more resources to other runtime tasks while maintaining a data-efficient cache of historic data access statements. This also enables a database management system to generate and maintain trace logs for a greater number of database operations than might otherwise be possible with conventional techniques. with reduced storage overhead because additionally embedding identifiers as comments into the data access statements can be avoided.

Hence, the overall storage footprint of a cache of historic data access statements that is maintained by the database agent can be reduced, and the negative impact on the performance of the database server and on the performance of other applications that are co-hosted on the same computer(s) on which the database server is hosted that is caused by an oversized, and, in cases where the data access statements are hashed prior to storage, fragmented, cache of historic data access statements can be minimized. A fragmented cache generally has a lower cache hit rate than a non-fragmented cache.

Further, the techniques described in the specification are broadly applicable to generating trace log messages for a wide variety of database commands, including database commands that are in the form of prepared statements, stored procedures, or functions.

A prepared statement (also referred to as a parameterized statement, or a parameterized query) takes the form of a pre-compiled template into which constant values are substituted during each execution, and typically use Structured Query Language (SQL) data manipulation language (DML) statements such as INSERT, SELECT, or UPDATE. Benefits of prepared statements include efficiency, because they can be used repeatedly without re-compiling, and security, because they reduce or eliminate SQL injection attacks.

A stored procedure is a subroutine available to applications that access a relational database management system. Such procedures can be stored in a database data dictionary. Benefits of using stored procedures include reduced server/client network traffic, stronger security, code reusability, easier maintenance, and improved database performance (e.g., reduced time needed to process the procedure). In the case of stored procedures, the generation of the context data takes place only during the initial execution of a stored procedure, and modifying the data access statement during any subsequent execution of the stored procedure will not impact the identifiers.

A function (e.g., a user-defined function) is a routine that accepts parameters, performs an action, such as a complex calculation, and returns the result of that action as a value. The return value can either be a single scalar value or a result set. Benefits of using functions include modular programming, faster execution times, and reduced server/client network traffic.

According to an aspect, there is provided a computer-implemented method comprising: establishing a session between an application running on a client system and a database server; receiving, by the database server, from the application, (i) a database command for an operation to be performed on a database hosted on the database server and (ii) context data for the session, wherein the context data comprises one or more identifiers; executing, by the database server, the database command to perform the operation on the database; and generating, by the database server, a trace log message comprising information about the operation being performed on the database by using the one or more identifiers included in the context data.

The one or more identifiers may comprise a trace identifier and a span identifier. Receiving the database command may comprise receiving the database command in form of a data access statement. The trace identifier may be associated with the session. The span identifier may be updated every time a new database command is submitted by the application during the session. Generating the trace log message may comprise: capturing, by the database server, one or more snapshots of the database server, wherein each snapshot comprises a plurality of attributes, the plurality of attributes comprising the one or more identifiers; and generating the trace log message based on the one or more snapshots by using the one or more identifiers included in the context data. The plurality of attributes may comprise one or more of: a status of the database, a status of the operation, a type of the database command, or a status of the database server. The plurality of attributes may comprise a hash derived from the database command that is generated by using a hash function to process the database command. Capturing the one or more snapshots of the database may comprise capturing the one or more snapshots of the database on a predetermined schedule. The method may further comprise: obtaining an application trace log message generated by the application running on the client system; obtaining a database trace log message generated by a database agent running on the database server; determining a correlation between the application trace log message and the database trace log message by using one or more identifiers included in the application trace log message; and performing one or more actions based on the correlation. The one or more actions may comprise one of: generating a presentation based on the trace log message and providing the presentation for display, storing the trace log message in a trace log, providing the trace log message to a code debugging system to debug source code of the database command based on the trace log message, or providing the trace log message to a performance analysis system to analyze a performance of the operation based on the trace log message.

According to another aspect, there is provided one or more computer-readable storage media encoded with instructions that, when executed by one or more computers, cause the one or more computers to perform the operations of the above method aspect.

According to yet another aspect, there is provided a system comprising one or more computers and one or more storage devices storing instructions that when executed by one or more computers cause the one or more computers to perform the respective operations of the above method aspect.

It will be appreciated that features described in the context of one aspect may be combined with features described in the context of another aspect.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a diagram illustrating an example environment that includes a client system and a database server.

FIG. 2 is a diagram illustrating an example database server.

FIG. 3 is a flow diagram illustrating an example process for generating one or more trace log messages.

FIG. 4 is a flow diagram illustrating an example process for using trace log messages.

FIG. 5 is a diagram of an example computer system.

### DETAILED DESCRIPTION

Techniques disclosed herein provide solutions for generating distributed trace logs that span the execution of applications and database management systems. Disclosed techniques use identifiers communicated as session context data to facilitate distributed trace logging. Since transmitting such identifiers as comments embedded in data access statements can be avoided, the disclosed techniques facilitate accurate capturing of trace log messages across servers, applications, or threads in a way that avoids negatively influencing the overall performance of the database server.

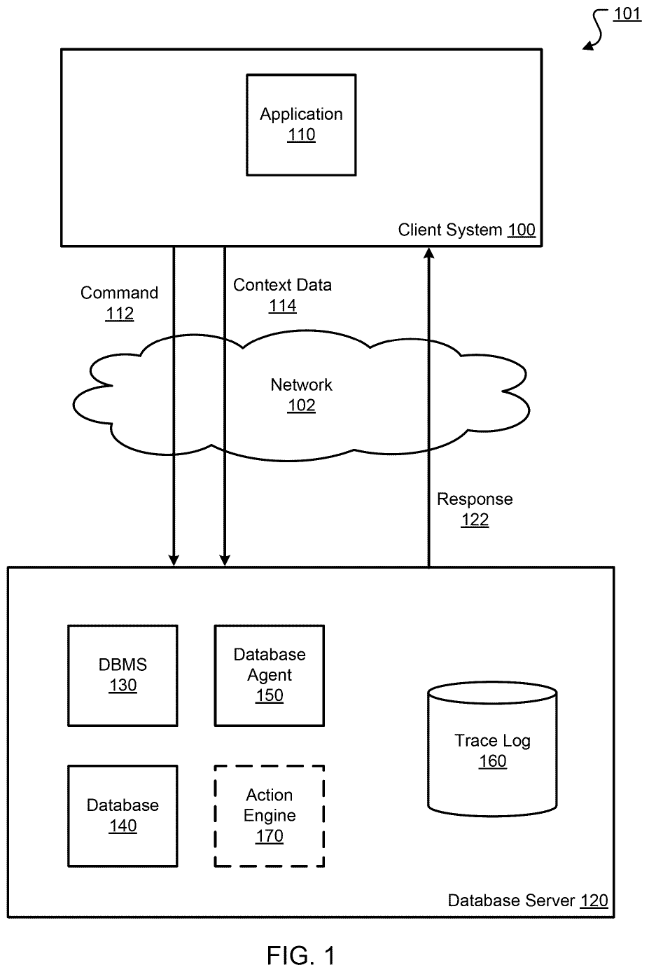

FIG. 1 is a diagram illustrating an example environment 101 that includes a client system 100 and a database server 120. The example environment 101 includes a network 102, such as a local area network (LAN), a wide area network (WAN), the Internet, or a combination thereof. The network 102 connects the client system 100 and the database server 120. The example environment 101 can include many different client systems 100 and database servers 120.

The database server 120 includes one or more database systems, e.g., database system 140. The database server 120 provides database services, e.g., database services for storing, querying, and updating data in the one or more database systems, or other types of database services.

As used herein, a database system (or “database” for short) refers to any computer system configured to store and/or process data. Examples of the database 140 include a relational database (e.g., a Structured query language (SQL) database), a non-relational database (e.g., a NoSQL database), and the like.

In some implementations, the database server 120 is a distributed database system that includes multiple nodes. A node can be a physical machine, a virtual machine, a computer, a server, a collection of physical machines or virtual machines, and so forth. In a distributed data system, one or more databases 140 are distributed across multiple distributed database elements. For example, a database 140 may be partitioned based on a partitioning key, and the partitions may be stored on two or more distributed database elements. Distributed database elements each store one or more partitions of a distributed database 140.

The database server 120 also includes a database management system (DBMS) 130. The DBMS 130 includes software that manages data stored in the database 140 and provides the client system 100 with access to the database system 140, e.g., allows the client system 100 to create, query, or update data stored in the database 140. In implementations where the database server 120 is a distributed database system that includes multiple nodes, the DBMS 130 can run on one or more of the multiple nodes.

The client system 100 typically runs on a client device that facilitates sending and receiving of data over the network 102. Examples of the client device include personal computers, mobile communication devices, digital assistant devices, augmented/virtual reality devices, and other electronic devices that can send and receive data over the network 102.

The client system 100 includes and runs an application 110 that can submit requests for database services to the database server 120 over the network 102. The application 110 can include any software program, e.g., either a stand-alone software program or a supplemental software program that works with and/or expands the capabilities of another software program, that can be installed on the client device. In some situations, the application 110 may thus also be referred to as a “software program 110” or a “program 110.”

Examples of the application 110 that is installed and runs on the client system 100 include a database application, a media application, an office application, and any other application that can make use of the database services provided by the database server 120 to perform various tasks that may involve storing and/or accessing the data.

In some implementations, the application 110 can be a web application. For example, the web application can be a web browser. As another example, the web application can be a plug-in module or other type of code module that executes as an extension to or within an execution environment provided by a web browser.

The application 110 interacts with the database server 120 by submitting database commands 112 that cause the database server 120 to perform operations on data stored in the database 140. A database command may also be referred to as a “database instruction 112,” a “database query 112,” a “database call 112,” or a “command 112.”

The commands 112 typically conform to a database language supported by the database server 120. Some common examples of a database language that is supported by the database server 120 include the Structured Query Language (SQL), the XML Path Language (XPath), or a database language that is integrated with a programming language, such as a JavaScript data query syntax.

In some implementations, the application 110 can submit a command 112 that includes a data access statement to access the database 140 that is included in the database server 120. Examples of data access statements that can be submitted by the application 110 include read, write, update, and delete statements. An example of the data access statement is a structured query language (SQL) statement. In some implementations, the application 110 can submit a command 112 that includes a prepared statement, a stored procedure, or a function (e.g., a user-defined function).

Prior to submitting the command 112, a session is established between the application 110 and the database server 120. The session may be initiated and established by application 110, by database server 120, other entity, or a combination thereof.

As used herein, a session is a specific connection of an application to a database server through a user process (e.g., a user-level process or a system-level process). For example, when a user of a client device on which the client system 100 is implemented starts the application 110, the user or client device typically provides the credentials, such as a token or a valid username and password. The credentials are sent from the application 110 to the database server 120. The database server 120 establishes a session for the user in response to receiving the credentials. The session can last from the time the application connects to the database server 120, e.g., until the time the user of the application 110 disconnects from the database server 120, until the time the user exits the application 110, after a predetermined amount of idle time, or the like.

At any time, the database server 120 can establish multiple sessions respectively with multiple applications that run on the same or different client systems. Each session usually involves multiple commands, e.g., multiple data access statements, multiple prepared statements, multiple stored procedures, or multiple functions.

When the database server 120 receives the data access statement of the command 112 from the application 110, the DBMS 130 of the database server 120 proceeds to execute the command 112 in accordance with an execution plan. There are many ways in which the execution plan for a data access statement can be obtained. For example, the execution plan can be retrieved from a cache if an execution plan associated with the data access statement already exists. As another example, the execution plan can be generated by using a statement parser and, optionally, a statement optimizer.

That is, in the latter example, the DBMS 130 can first determine which actions should be performed in response to the command 112, and then perform those actions. The act of preparing for and/or determining for performance of those actions may be referred to as compiling the command 112, while performing those actions may be referred to as executing the command 112.

After having executed the command 112, the DBMS 130 can generate a response 122 to the command 112, and the database server 120 can provide the response 122 to the application 110 which submitted the command 112. For example, when the command 112 includes a data access statement to read certain data stored in the database 140, the response 122 can include the data retrieved by the DBMS 130 from the database 140 in accordance with the command 112.

A database agent 150 can communicate with the database server 120 to monitor and track the internal functionality and the actual status of the database server 120 to generate trace log messages. The database agent 150 can run on database server 120 or can run on another device that is in communication with database server 120 (e.g., communicatively coupled). In some implementations where the database server 120 is a distributed database system that includes multiple nodes, the database agent 150 can run on one or more of the multiple nodes, which may be, but need not be, the same nodes on which the DBMS 130 is running.

When the application 110 submits a command 112 in the form of a data access statement to perform a database operation on the database 140, the database agent 150 can generate trace log messages which describe details for the operations performed by the DBMS 130 and, possibly, other components of the database server 120 to execute data access statement.

In some cases, during execution of the command 112, the application 110 can perform trace logging to generate application trace log data that includes trace log messages. In practice this can be achieved by way of instrumentation, e.g., through manual or automatic code insertion into the source code of the application 110.

While this specification describes implementations where the database agent 150 is a separate component from the DBMS 130 and executes as a process separate from a process executing the DBMS 130, in other implementations, the agent can be part of the DBMS 130 and can be statically linked or dynamically loaded or linked to DBMS 130 in which case the database agent 150 might execute as part of one or more processes executing the DBMS 130.

In addition, during execution of the command 112, the database agent 150 can perform trace logging to generate database trace log data that includes trace log messages. Having generated the trace log messages, the database agent 150 can add the trace log messages (as part of the database trace log data) to a trace log 160 in which the trace log messages are stored. Likewise, in cases when it is instrumented with trace logging, the application 110 can add the trace log messages (as part of the application trace log data) to the trace log 160 or a separate trace log.

The trace log 160 can be maintained at the database server 120 or a remote server. A trace log is a computer log used for the primary purpose of troubleshooting errors or problems that arise within the database server 120 at runtime, analyze database system or application behavior, and so on, by software developers, system administrators, and other personnel.

The database agent 150 is configured to use snapshot data (or “snapshots” for short) to generate the trace log messages. Typically, a snapshot of the database server 120 represents a large amount of data about the internal functionality and actual status of the database server 120. Capturing multiple snapshots within a time period can thus deliver continuous information about the internal functionality of the database server 120 during the time period. For example, by using snapshots, the database agent 150 can continuously measure the times to store data, the required times to find and read data, and the times to delete data.

In particular, the trace log messages can include distributed trace log messages. A distributed trace log message includes, e.g., a trace log message that spans multiple locations, e.g., that spans the application 110 that is included in the client system 100 and the DBMS 130 that is included in the database server 120.

Distributed trace logging generally involves one or more traces and one or more spans. A trace can correspond to the entire session that is established between the database server 120 and the application 110. A trace can start when the session begins. All trace events generated during the session can share a trace identifier (TraceID) that can be used to organize, filter and search for specific traces.

Each trace can include one or more spans. Each command in the multiple commands included during the session can correspond to a span. Each span can start when the execution of a corresponding command begins. The span can represent a journey of the corresponding command within the database server 120 as the corresponding command is being processed by the DBMS 130 and, possibly, other components of the database server 120. Each span can include a unique span identifier (SpanID).

To facilitate distributed trace logging by the database agent 150, the application 110 thus provides one or more identifiers (IDs) to the database server 120. The one or more identifiers can include one or more trace identifiers (TraceIDs), one or more span identifiers (SpanIDs), or both. In some implementations, a TraceID can be a unique 32-character universally unique identifier (UUID) string. In some implementations, a SpanID can be a unique 16-character string.

Notably, the database server 120 receives the one or more identifiers from the application 110 as part of the session context data 114 (or “context data 114” for short) for the session that has been established between the database server 120 and the application 110.

This is in contrast to some other database management systems that receive the one or more identifiers as part of the command 112. For example, rather than receiving the one or more identifiers as context data 114, another system would alternatively receive a command that includes data access statements and the one or more identifiers embedded as comments of the data access statements, e.g., comments that are added by an application to a data access statement before submitting a command that includes the data access statement to the system.

While comments are generally ignored by compilers and interpreters, and therefore may not affect the operation of the DBMS, they can negatively influence the overall performance of the DBMS for a number of reasons. For one, commands with the same data access statements but different comments will need to be separately stored in a cache of historic commands, oftentimes resulting in an oversized historic command cache. For another, in cases where the commands are hashed prior to storage, the historic command cache may become fragmented, thereby lowering its cache hit rate. Furthermore, comments in data access statements might produce incorrect trace logs when the commands are in the form of prepared statement, stored procedure, or function.

By virtue of receiving the one or more identifiers that facilitate distributed trace logging as context data 114 for the session and rather than as part of the command 112, the database agent 150 can monitor and track the internal functionality and the actual status of the database server 120 to generate trace log messages in a way that avoids negatively influencing the overall performance of the database server 120.

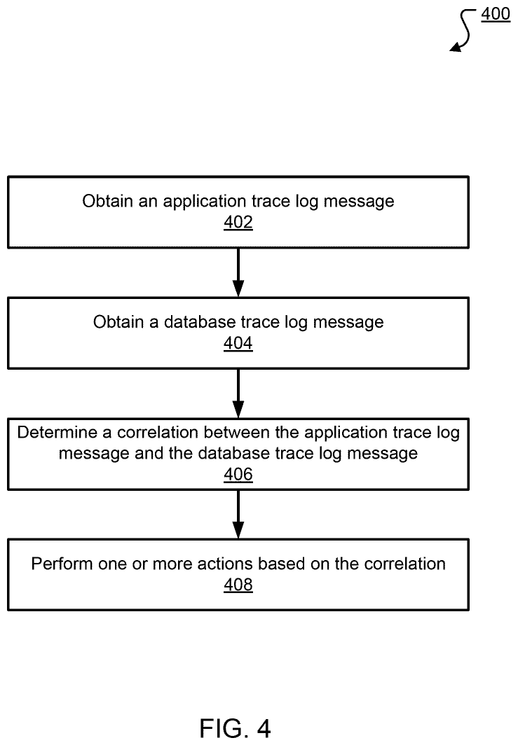

In some implementations, the database server 120 includes an action engine 170 that has access to the trace log 160. As an optional component of the database server 120, the action engine 170 can be configured to perform any of a variety of actions either in real-time or in a post-hoc manner. Some examples of the actions that the action engine 170, when included in the database server 120, can perform will be discussed further below with reference to FIG. 4.

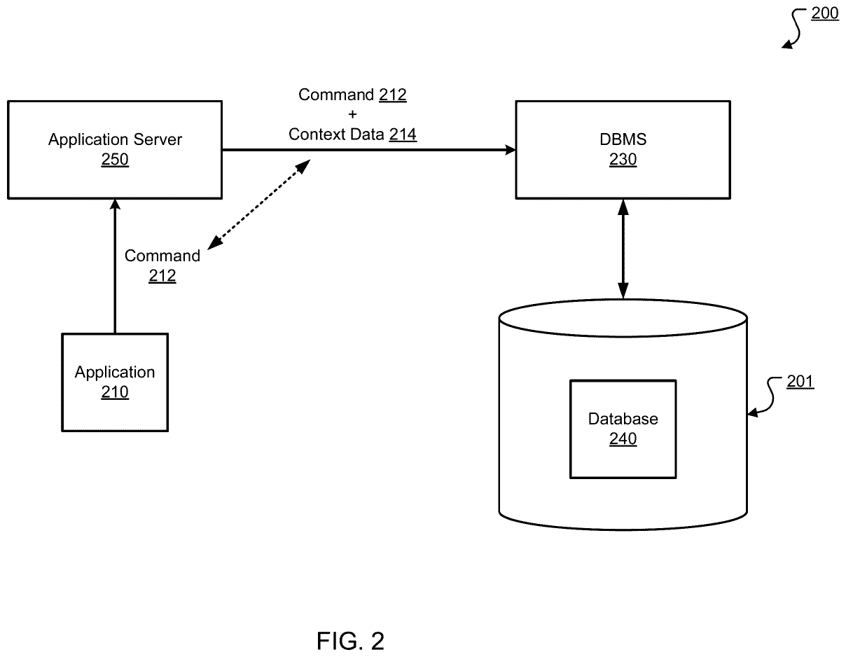

FIG. 2 is a diagram illustrating an example database server 200. For example, the database server 200 can correspond to the database server 120 illustrated in FIG. 1. The database server 200 has a three-layered architecture as shown.

A first (bottom) layer is a hardware layer, which is the core of the database server 200. The first (bottom) layer includes a central storage 201 that stores and maintains a database 240. The database 240 typically resides on one or more hard drives, and is generally part of a larger computer system. The data can be stored in the database 240 in a variety of formats. An example is a relational database which uses tables to store the data.

A second (middle) layer is a session layer. The session layer includes a database management system (DBMS) 230 and an application server 250. There can be multiple database management systems in the database server 200. The database management system (DBMS) 230 interacts with the database 240. Each instance of a database server can, among other features, independently query the database and store data in the database 240. Depending on the implementation, the DBMS 230 may or may not include user-friendly interfaces, such as graphical user interfaces. There can be multiple application servers.

In some implementations, the application server 250 provides the user interfaces to the DBMS 230. For example, the application server 250 can be a database application server on the Internet or any other network. Alternatively, the application server 250 can also be a virtual database server, a virtual directory server, or the like. The application server 250 can provide user-friendly mechanisms and interfaces for accessing the database 240 through the DBMS 230.

A third (top) layer is an application layer. The application layer includes the application server 250 and the application 210. The application 210 can be utilized to access the DBMS 230. For example, the application 210 can run on a client device that is remote from the database server 200.

In some implementations, the application 210 can establish a connection to the application server 250; the application 210 can generate and send a database command 212 to the application server 250 through the connection. In this manner, the communication of the database commands 212 occurs at the top layer, i.e., the application layer, of the database server 200.

In these implementations, the application server 250 can likewise establish a connection to the DBMS 230; the application server 250 can generate session context data 214 and send the generated session context data 214, together with the database command 212 (which has been received from the application 210), through the connection to the DBMS 230. In this manner, the communication of the session context data 214 occurs at the middle layer, i.e., the session layer, of the database server 200.

As previously mentioned, the context data 214 can include one or more identifiers (IDs), e.g., one or more trace identifiers (TraceIDs), one or more span identifiers (SpanIDs), or both. In practice a time synchronization (as indicated by the dashed arrow) can be maintained between the application layer and the middle layer, such that the context data 214 will be modified (e.g., updated) to include one or more new identifiers every time a new database command 212 is received from the application 210.

In particular, in these implementations, the communication of the database commands 212 and the communication of the session context data 214 occur at different layers—namely at the application layer and the session layer, respectively—of the three-layered architecture the database server 200 as shown in FIG. 2.

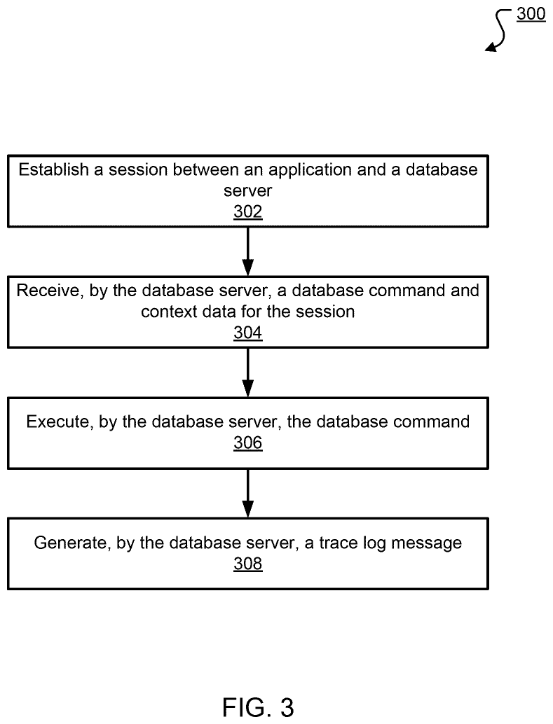

FIG. 3 is a flow diagram illustrating an example process 300 for generating one or more trace log messages. For convenience, the process 300 will be described as being performed by a system of one or more computers located in one or more locations. For example, a database server, e.g., the database server 120 of FIG. 1, appropriately programmed in accordance with this specification, can perform the process 300. The database server includes a database, a database management system (DBMS), and a database agent.

The database server establishes a session between an application and the database server (step 302). The application runs on a client system that is implemented on a client device. The client device can be physically remote from the database server.

The database server receives, from the application, (i) a command for an operation to be performed on the database hosted on the database server and (ii) context data for the session that has been established between the database server and the application (step 304). In some implementations, the database server has a three-layered architecture, where communication of the commands and the communication of the context data occur at different layers of the three-layered architecture.

In some implementations, the command can include a data access statement, e.g., a structured query language (SQL) statement. Examples of data access statements that can be submitted by the application include read, write, update, and delete statements. In some implementations, the command can include a prepared statement, a stored procedure, or a function (e.g., a user-defined function). In some implementations, the command need not include any comments that provide information to facilitate distributed trace logging and that are added to the data access statement.

Generally, the context data includes context information about the session, e.g., a network address of the application, a geographical location of the client device, network protocol information, the transaction isolation levels of the commands, and so forth.

In particular, in addition, the context data includes one or more identifiers. The one or more identifiers can include one or more application identifiers (e.g., Application key), trace identifiers (TraceIDs), one or more span identifiers (SpanIDs), other identifiers, or a combination thereof.

In implementations, the context data can be dynamically updated throughout the session. The application can generate and communicate context data that includes a trace identifier (TraceID) upon initiation of the session. The trace identifier can identify a trace. The trace can start when the session begins. The trace identifier can thus identify the entire session.

Then, throughout the session, at a time the application submits a command to the database server, the application can generate and communicate updated context data that additionally includes a span identifier (SpanID). The span identifier can identify a span. The span can start when the execution of the command begins. The span identifier can thus identify the command.

As previously mentioned, each session usually involves multiple commands. Thus, every time the application submits a new command to the database server, the application can generate and communicate updated context data that additionally includes a different, new span identifier (SpanID) that can identify the new command.

The application can be configured to do this in any of a variety of ways. For example, the application can replace a prior span identifier (SpanID) that identifies a prior command that has already been executed by the database server with a new span identifier (SpanID) that identifies a new command to be executed by the database server. That is, the application continuously updates the span identifiers (SpanIDs) as the application submits new commands to the database server.

As another example, the application can append (or prepend) a new span identifier (SpanID) that identifies a new command to be executed by the database server to the end of (or the beginning of) a sequence of historical span identifiers (SpanIDs) that respectively identify the historical command that have already been executed by the database server.

In cases where the session involves multiple commands, the database server can receive context data that includes a trace identifier (TraceID) and multiple span identifiers (SpanIDs) which are different from each other. From another point of view, while there may be a single trace identifier (TraceID) associated with the same application, there can generally be multiple different span identifiers (SpanIDs) associated with the same application.

In cases where another session is established between a different application and the database server, and the database server receives a command from the different application during the other session, the database server can receive different context data that is changed to include a different trace identifier (TraceID) which identifies the other session with the different application.

The database server uses the database management system (DBMS) to execute the command to perform the operation on the database (step 306). The DBMS can execute the command in accordance with an execution plan. After having executed the command, the DBMS generates a response to the command, and the database server provides the response to the application which submitted the command. For example, when the command includes a data access statement to read certain data stored in the database, the response can include the data retrieved by the DBMS from the database in accordance with the command.

The database server uses the database agent to generate one or more trace log messages based on the context data (step 308). The one or more trace log messages can include a distributed trace log message. In some implementations, the database agent can use snapshot data to generate the trace log messages.

Snapshots of the database server can be captured by the database agent based upon a trigger condition. For example, snapshots can be captured on a predetermined schedule, e.g., at predetermined time intervals, while the DBMS is executing the command. As another example, snapshots can be captured when a snapshot condition defined in the source code of the application has been satisfied.

Usually, a snapshot of the database server can include a large amount of information about the internal functionality and actual status of the database server. Other information related to events in the database, e.g., a notification about started and finished commands or other events, e.g., an alert about certain events, can also be included in the snapshot.

In some implementations, each snapshot can include a plurality of attributes. For example, the plurality of attributes can include, but is not limited to, one or more of:
a status of the database included in the database server;
a status of the operation that is performed by the DBMS on the database;
a status of the database server;
a type of the command (e.g., whether the command includes a read, write, update, or delete statement);
an elapsed time (such as session duration);
a timestamp associated with the command;
a user that submits the command;
an IP address of the application;
information about the source code of the application (e.g., filename, line of code, and version of the source code);
a hash value derived from the command that is generated by using a cryptographic hash function to process the command (where examples of cryptographic hash functions include the Secure Hash Algorithm (SHA) and its variations, and the Message Digest algorithm (MD) and its variations, to name just a few).

In particular, in addition, the plurality of attributes also include the one or more identifiers, e.g., one or more trace identifiers (TraceIDs), one or more span identifiers (SpanIDs), or both, that are received by the database server as part of the context data for the session. In this manner, the database agent can generate the trace log message based on using the one or more identifiers included in the context data. For example, a trace log message can include information (e.g., including the one or more identifiers) that is included in a snapshot, additional log data that can be derived from the information, or both.

An example way of how to use the trace log messages that have been generated based on the one or more snapshots by using the identifiers included in the context data is described below.

FIG. 4 is a flow diagram 400 illustrating an example process for using trace log messages. For convenience, the process 400 will be described as being performed by an action engine implemented at software on one or more computers located in one or more locations. There are many ways in which the action engine can be implemented.

In some implementations, the action engine includes software developed by a third-party entity, i.e., an entity that is affiliated with neither the database server 120 nor the application 110. In some implementations, the action engine is hosted on the database server 120 that also hosts the database agent 150. In fact, in some of these implementations, the action engine can be implemented as part of, e.g., as one or more built-in features of, the database agent. In some other implementations, however, the action engine is included in a separate server, e.g., a backend server, that is physically remote from the database server 120 that hosts the database agent 150.

The action engine obtains an application trace log message that has been generated by the application that is running on the client system (step 402). The application trace log message can be generated by the application (as part of the application trace log data) at any time point during an operation that is being performed on the database hosted on the database server by the DBMS in response to a command from the application. For example, the action engine can obtain such a trace log message from a trace log that is accessible by the application.

The action engine obtains a database trace log message that has been generated by the database agent that is running on the database server (step 404). The database trace log message can be generated by the database agent (as part of the database trace log data) using the techniques described above, at any time point during the operation that is being performed on the database hosted on the database server by the DBMS in response to the command from the application, e.g., as the application is also generating application trace log messages. For example, the action engine can obtain such a trace log message from the trace log that also stores the application trace log data, or from a different trace log that is accessible by the database agent.

The action engine determines a correlation between the application trace log message and the database trace log message (step 406). In some implementations, because the database trace log message includes the one or more identifiers, e.g., the one or more trace identifiers (TraceIDs) and the one or more span identifiers (SpanIDs), the action engine can determine that the application trace log message correlates to the database trace log message based on comparing the one or more identifiers that are included in the database trace log message to the one or more identifiers that may be similarly included in the application trace log message to identify common (or matching) identifiers. For example, an action engine can determine that an application trace log message correlates to a database trace log message when they include one or more common identifiers.

The action engine performs one or more actions based on correlation (408). There are many actions that can be performed. A few examples are discussed below.

In some implementations, the action engine can generate a visual presentation based on the application and/or database trace log messages, e.g., that reflects the correlation between the application and database trace log messages, and then provide the visual presentation for display on an output device. Examples of the visual presentation include a flame graph highlighting long-running commands, a waterfall chart showing the timeline of database operations within a command, a service dependency graph indicating bottlenecks between services and the database, and so forth.

In some implementations, the action engine can make real-time changes to the DBMS based on the application and/or database trace log messages to guarantee or improve the performance of the database server. For example, the action engine can terminate a long-running command, e.g., by terminating the process in which operations corresponding to the command are executing.

In some implementations, the action engine can output the application and/or database trace log messages for storage in a trace log or to another system for further processing. For example, the action engine can provide the application and/or database trace log messages to a code debugging system to debug source code of the command based on the application and/or database trace log messages. As another example, the action engine can provide the application and/or database trace log messages to a performance analysis system to analyze a performance of the operation based on the application and/or database trace log messages.

Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, the client system 100 can be implemented using digital electronic circuitry, or in computer software, firmware, or hardware, or in combinations of one or more of them. In another example, the database server 120 can be implemented using digital electronic circuitry, or in computer software, firmware, or hardware, or in combinations of one or more of them.

Some implementations described in this specification (e.g., DBMS 130, database agent 150, etc.) can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. In some implementations, the client system 100 and the database server 120 each comprise a data processing apparatus as described herein. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

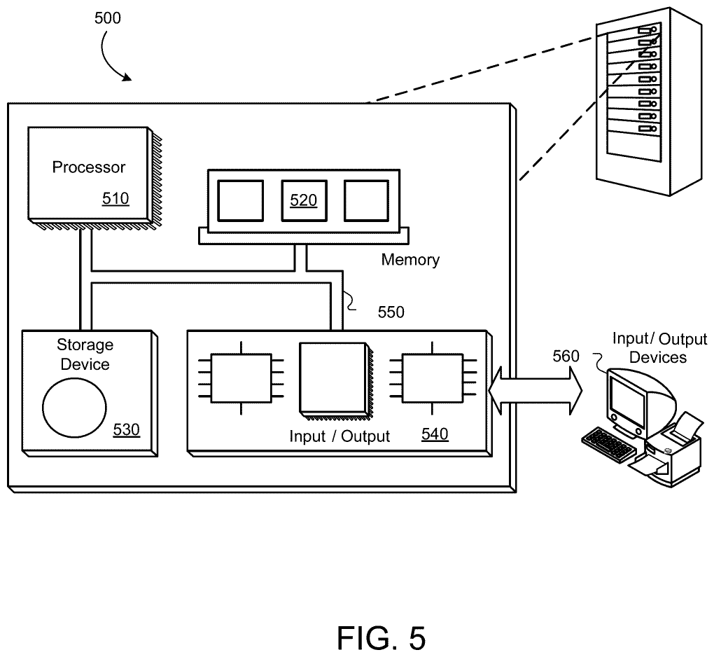

FIG. 5 shows an example computer system 500 that includes a processor 510, a memory 520, a storage device 530 and an input/output device 540. Each of the components 510, 520, 530 and 540 can be interconnected, for example, by a system bus 550. The processor 510 is capable of processing instructions for execution within the system 500. In some implementations, the processor 510 is a single-threaded processor, a multi-threaded processor, or another type of processor. The processor 510 is capable of processing instructions stored in the memory 520 or on the storage device 530. The memory 520 and the storage device 530 can store information within the system 500.

The input/output device 540 provides input/output operations for the system 500. In some implementations, the input/output device 540 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 560. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the spirit and scope of the data processing system described herein. Accordingly, other embodiments are within the scope of the following claims.

What is claimed is:

1. A computer-implemented method comprising:
establishing a session between an application running on a client system and a database server;
receiving, by the database server, from the application, (i) a database command for an operation to be performed on a database hosted on the database server and (ii) context data for the session, wherein the context data comprises one or more identifiers;
executing, by the database server, the database command to perform the operation on the database; and
generating, by the database server, a trace log message comprising information about the operation being performed on the database by using the one or more identifiers included in the context data.

2. The method of claim 1, wherein the one or more identifiers comprise a trace identifier and a span identifier.

3. The method of claim 1, wherein receiving the database command comprises receiving the database command in form of a data access statement.

4. The method of claim 2, wherein the trace identifier is associated with the session.

5. The method of claim 2, wherein the span identifier is updated every time a new database command is submitted by the application during the session.

6. The method of claim 1, wherein generating the trace log message comprises:
capturing, by the database server, one or more snapshots of the database server, wherein each snapshot comprises a plurality of attributes, the plurality of attributes comprising the one or more identifiers; and
generating the trace log message based on the one or more snapshots by using the one or more identifiers included in the context data.

7. The method of claim 6, wherein the plurality of attributes comprise one or more of: a status of the database, a status of the operation, a type of the database command, or a status of the database server.

8. The method of claim 6, wherein the plurality of attributes comprise a hash derived from the database command that is generated by using a hash function to process the database command.

9. The method of claim 6, wherein capturing the one or more snapshots of the database comprises capturing the one or more snapshots of the database on a predetermined schedule.

10. The method of claim 6, further comprising:
obtaining an application trace log message generated by the application running on the client system;
obtaining a database trace log message generated by a database agent running on the database server;
determining a correlation between the application trace log message and the database trace log message by using one or more identifiers included in the application trace log message; and
performing one or more actions based on the correlation.

11. The method of claim 10, wherein the one or more actions comprise one of:
generating a presentation based on the trace log message and providing the presentation for display,
storing the trace log message in a trace log,
providing the trace log message to a code debugging system to debug source code of the database command based on the trace log message, or
providing the trace log message to a performance analysis system to analyze a performance of the operation based on the trace log message.

12. A system comprising at least one processor and a memory storing instructions that, when executed by the at least one processor, cause the at least one processor to perform operations comprising:
establishing a session between an application running on a client system and a database server;
receiving, by the database server, from the application, (i) a database command for an operation to be performed on a database hosted on the database server and (ii) context data for the session, wherein the context data comprises one or more identifiers;
executing, by the database server, the database command to perform the operation on the database; and
generating, by the database server, a trace log message comprising information about the operation being performed on the database by using the one or more identifiers included in the context data.

13. The system of claim 12, wherein the one or more identifiers comprise a trace identifier and a span identifier.

14. The system of claim 12, wherein receiving the database command comprises receiving the database command in form of a data access statement.

15. The system of claim 13, wherein the trace identifier is associated with the session.

16. The system of claim 13, wherein the span identifier is updated every time a new database command is submitted by the application during the session.

17. The system of claim 12, wherein generating the trace log message comprises:
capturing, by the database server, one or more snapshots of the database server, wherein each snapshot comprises a plurality of attributes, the plurality of attributes comprising the one or more identifiers; and
generating the trace log message based on the one or more snapshots by using the one or more identifiers included in the context data.

18. The system of claim 17, wherein the operations further comprise:
obtaining an application trace log message generated by the application running on the client system;
obtaining a database trace log message generated by a database agent running on the database server;
determining a correlation between the application trace log message and the database trace log message by using one or more identifiers included in the application trace log message; and
performing one or more actions based on the correlation.

19. The system of claim 18, wherein the one or more actions comprise one of:
generating a presentation based on the trace log message and providing the presentation for display,
storing the trace log message in a trace log,
providing the trace log message to a code debugging system to debug source code of the database command based on the trace log message, or
providing the trace log message to a performance analysis system to analyze a performance of the operation based on the trace log message.

20. One or more non-transitory computer readable media storing instructions for monitoring operations of a computing device, the instructions, when executed by at least one processor, configured to cause the at least one processor to perform operations comprising:
establishing a session between an application running on a client system and a database server;
receiving, by the database server, from the application, (i) a database command for an operation to be performed on a database hosted on the database server and (ii) context data for the session, wherein the context data comprises one or more identifiers;
executing, by the database server, the database command to perform the operation on the database; and
generating, by the database server, a trace log message comprising information about the operation being performed on the database by using the one or more identifiers included in the context data.
